(19) United States
(12) Patent Application Publication
(10) Pub. No.: US 2025/0322335 A1
(43) Pub. Date: Oct. 16, 2025

(54) PCBA FIRST ARTICLE INSPECTION METHOD AND SYSTEM, ELECTRONIC DEVICE, AND STORAGE MEDIUM

(71) Applicant: Vayo (Shanghai) Technology Co., Ltd., Shanghai (CN)

(72) Inventors: Shengjie QIAN, Shanghai (CN); Jishuo LIU, Shanghai (CN); Fengshou LIU, Shanghai (CN)

(73) Assignee: Vayo (Shanghai) Technology Co., Ltd., Shanghai (CN)

(21) Appl. No.: 18/869,854

(22) PCT Filed: Aug. 1, 2022
(86) PCT No.: PCT/CN2022/109351

§ 371 Date: Nov. 27, 2024

(30) Foreign Application Priority Data
May 30, 2022 (CN) 202210602772.7

(51) Int. Cl. G06Q 10/0631; G06F 30/398

(52) U.S. Cl. CPC G06Q 10/06316; G06F 30/398

(57) ABSTRACT

A PCBA first article inspection method and system, an electronic device, and a storage medium are provided. The method includes: obtaining a whole-board virtual assembly graph, a PCBA physical image, and a first CAD component list; extracting a component list L4; at a server, obtaining a second CAD component list, generating a task list, generating a check list, and assigning a current task number to at least n₁ users not having a task; at a user end, obtaining the current task number based on the task list, and obtaining status of the current task number, to obtain a check list updated according to the status in the check list and a check result; and at the server, obtaining a task list whose status is closed and whose current task number is cleared, and generating and outputting a report of the current task number.

### FIELD OF THE INVENTION

The present disclosure relates to the technical field of electronic manufacturing, and specifically, to a PCBA first article inspection method and system, an electronic device, and a storage medium.

### BACKGROUND

Printed Circuit Board Assembly (PCBA) first article inspection refers to an operation of inspecting the first or first few products produced in each batch in a production process. This operation is also called the first article inspection since it is carried out by sampling a particular amount of samples before mass production. The number of pieces for first article inspection may vary according to the requirements of enterprises or customers, and the products are to be put into mass production only after the first article inspection is qualified. The main object of the first article inspection in the production process is to avoid problems such as out-of-tolerance, after-sales services, or scrap of products, and is a means of controlling a production process of products in advance, an important method for product process quality control, and an effective and essential method for enterprises to ensure the product quality and improve the economic efficiency. Long-term practical experience has proved that the first article inspection system is an effective measure to find problems as soon as possible and prevent products from being scrapped in batches.

Through the first article inspection, the problems such as whether the product has missing parts, position deviation, or reverse, wrong polarity or missing components, feeding or formula errors can be found, so as to take corrective or improvement measures to prevent the occurrence of batch unqualified products. The first batch production of new products and the semi-finished products and finished products produced after the change of materials and specifications need to be inspected and confirmed. During the first article inspection, first article record needs to be made in time and a first piece confirmation needs to be filled in.

In a conventional method, the PCBA first article inspection is usually carried out visually by inspecting a physical PCBA using a magnifying glass by staff; when it comes to a PCBA having a relatively large number of components, the inspection depending an individual is time-consuming and is apt to hurt the eyes of the staff, and in addition, due to a long time online work of the staff, an increase in the inspection error rate is caused.

### SUMMARY

The present disclosure provides a PCBA first article inspection method and system, an electronic device, and a storage medium.

The PCBA first article inspection method includes: obtaining a whole-board virtual assembly graph, a PCBA physical image, and a first CAD component list; extracting a component list L4 from the first CAD component list, where the component list L4 includes all components for first article inspection; at a server, updating the first CAD component list based on a number of times of check of components in multi-check settings, to obtain a second CAD component list, generating a task list based on the component list L4, and generating a check list based on the second CAD component list and the component list L4, to assign a current task number in the task list to at least n₁ users not having a current task; at a user end, obtaining the current task number based on the task list, and obtaining status of the current task number, to obtain, when the status of the current task number is incomplete or complete, a check list updated according to the status in the check list and a check result; and at the server, after all results in the check list are updated, obtaining a task list whose status is closed and whose current task number is cleared, and generating and outputting a report of the current task number.

The PCBA first article inspection system includes an obtaining module, a component list generation module, an assignment module, a check list update module, and a report generation module.

The obtaining module can obtain a whole-board virtual assembly graph, a PCBA physical image, and a first CAD component list.

The component list generation module can extract a component list L4 from the first CAD component list. The component list L4 includes all components for first article inspection.

The assignment module is disposed at a server, and can update the first CAD component list based on a number of times of check of components in multi-check settings, to obtain a second CAD component list, generate a task list based on the component list L4, and generate a check list based on the second CAD component list and the component list L4, to assign a current task number in the task list to at least n₁ users not having a current task.

The check list update module is disposed at a user end, and can obtain the current task number based on the task list, and obtain status of the current task number, to obtain, when the status of the current task number is incomplete or complete, a check list updated according to the status in the check list and a check result.

The report generation module is disposed at the server. After all results in the check list are updated, the report generation module can obtain a task list whose status is closed and whose current task number is cleared, and generate and output a report of the current task number.

The electronic device includes a processor, a communication interface, a memory, and a communication bus. The processor, the communication interface, and the memory complete communication with each other through the communication bus. The memory is configured to store a computer program. The processor is configured to implement, when executing the computer program, any of the steps of the foregoing PCBA first article inspection method.

The storage medium has a computer program stored thereon. The computer program, when executed by a processor, implements the steps of the foregoing PCBA first article inspection method according to any one of the above items.

The beneficial effects of the present disclosure are as follows.

In the present disclosure, the component list L4 including all of the components for the first article inspection is generated, and at the server, the task list and the check list are generated, so that a task currently required to be performed can be assigned to the user end of a user needing to perform the task. Then, at the user end, the user can perform the task whose status of the current task number is complete or incomplete, to obtain the check list having the check result, so as to finally output the corresponding report. Therefore, by the present disclosure, the inspection tasks can be dynamically assigned, the first article inspection can be performed by multiple people in parallel, multiple times of re-check or cross-check can be set, so that the time is shortened, and the error rate of inspection is reduced.

The present disclosure is further described in detail below with reference to the accompanying drawings and embodiments.

### BRIEF DESCRIPTION OF THE DRAWINGS

FIG. 1 is a schematic flowchart of a PCBA first article inspection method according to an embodiment of the present disclosure.

FIG. 2 is a schematic diagram of a component image according to an embodiment of the present disclosure.

FIG. 3 is a schematic diagram of a virtual assembly graph single box according to an embodiment of the present disclosure.

FIG. 4 is a schematic diagram of a PCBA physical image single box according to an embodiment of the present disclosure.

FIG. 5 is a schematic diagram of single boxes of a virtual assembly graph at an angle of 90° and at an angle of 0° according to an embodiment of the present disclosure.

FIG. 6 is a schematic diagram of a reset-to-zero interface according to an embodiment of the present disclosure.

FIG. 7 is a schematic diagram of a non-reset-to-zero interface according to an embodiment of the present disclosure.

FIG. 8 is a schematic diagram of a display interface according to an embodiment of the present disclosure.

FIG. 9 is a schematic diagram of a PCBA first article inspection system according to an embodiment of the present disclosure.

FIG. 10 is a schematic structural diagram of an electronic device according to an embodiment of the present disclosure.

### DETAILED DESCRIPTION

The present disclosure is further described in detail below with reference to specific embodiments, but the embodiments of the present disclosure are not limited thereto.

### Embodiment 1

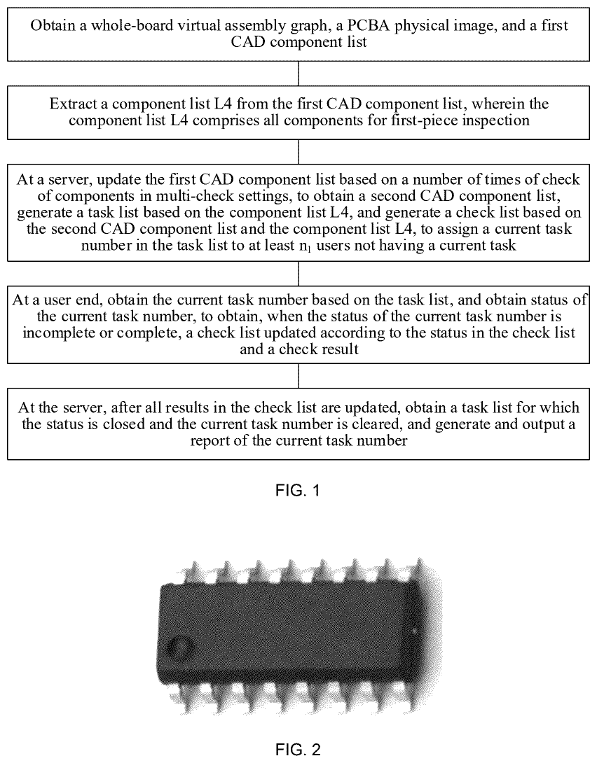

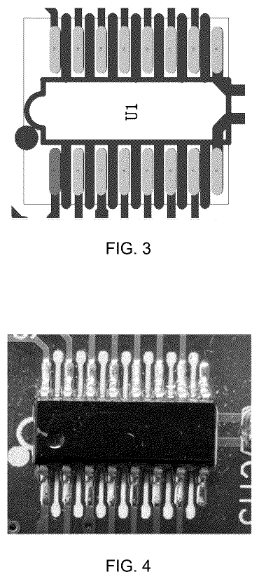

Referring to FIG. 1, FIG. 1 is a schematic flowchart of a PCBA first article inspection method according to an embodiment of the present disclosure. This embodiment provides a PCBA first article inspection method. The PCBA first article inspection method may include:

Step 1: Obtain a whole-board virtual assembly graph, a PCBA physical image, and a first CAD component list.

The whole-board virtual assembly graph is an image after all components of a design file are simulated and assembled. The PCBA physical image is an image corresponding to a PCBA board. The first CAD component list includes all of the components in the design file. The first CAD component list includes position numbers of the components, material numbers (that is, material serial numbers), whether having polarities, front and back sides, and a number of times of check.

In addition, in an example, a component library is further preset. The component library stores material serial numbers of all existing components, physical images of the components (also referred to as component images, for example, as shown in FIG. 2), and sizes of check boxes. The sizes of the check boxes correspond to sizes of the components.

In a specific embodiment, step 1 may include step 1.1 to step 1.3.

Step 1.1: Form the whole-board virtual assembly graph by combining a bill of material (BOM) and at least one CAD design file.

Specifically, the CAD design file includes component names, position numbers, material serial numbers, whether the components have polarities, front and back sides, position coordinates, angles, and sizes of set component virtual check boxes. After reading the BOM in combination with the CAD design file, the whole-board virtual assembly graph (a silk screen, or a pad) is formed.

Step 1.2: Obtain the PCBA physical image corresponding to a PCBA board.

Specifically, the PCBA board is scanned or photographed by Automated Optical Inspection (AOI), so that a PCBA physical image can be obtained by setting a physical size of the PCBA image. The PCBA physical image and the whole-board virtual assembly graph have a same size.

Step 1.3: Form the first CAD component list including all of the components based on the CAD design file.

Specifically, the position numbers, material numbers, polarities, whether having polarities, front and back sides of the components needed in the first CAD component list are retrieved by using the CAD design file, and the number of times of check in the first CAD component list is 1 by default.

In addition, the virtual first article inspection graph may further be generated. Specifically, the generating of the virtual first article inspection graph may include: overlapping the whole-board virtual assembly graph and the PCBA physical image at a 1:1 proportion (that is, overlapping front sides and back sides in a board inlet direction), to obtain the virtual first article inspection graph.

Step 2: Multi-check setting and check condition.
(1) When the components on the whole-board virtual assembly graph have polarities, a number of times of multi-check n is set, where n≥2. For example, when n=2, double check is performed, and the components are manually checked twice by different personnels.
(2) When the components on the whole-board virtual assembly graph have no polarities, a single check is set.
(3) Check condition: Whether a component on the PCBA physical image is missing, reverse, or offset is determined by using the whole-board virtual assembly graph as a reference; whether a component on the PCBA physical image is wrong/damaged is determined by using the physical component image as a reference, that is, whether a component on the PCBA physical image is missing, reverse, offset, or wrong/damaged is checked.

Step 3: Extract a component list L4 from the first CAD component list, where the component list L4 includes all components for first article inspection.

Specifically, components on which first article inspection needs to be performed are selected from the first CAD component list, to generate the component list L4. First article inspection components are pre-set. For example, the first article inspection components may be a front component and/or a back component, or front and back components in the first CAD component list, or may be a component manually selected.

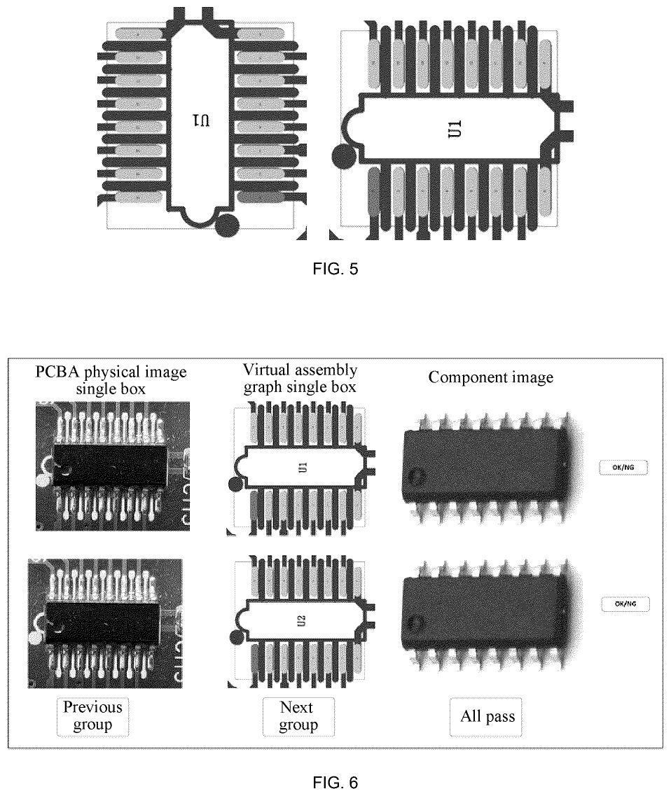

Step 4: Set a number of inspectors and set an assignment condition.
a. Set the number of inspectors:
(1) Set a PCBA first article check time t.
(2) Obtain a total number of times of check Q on the components on the component list L4.
(3) An estimated time for one individual to process one component is t₁, t₁ may be a value set according to experience firstly, and may be updated continuously according to an average time of a single component inspection in the report. The update method includes: calculating an average of average time of all single component inspection in the report.
(4) Number of people for tasks: n₁=Q*t₁/t.
b: Set the assignment condition.
(1) A single group number g is recommended, and the single group number is a number of components displayed on an interface each time when a current task number is executed.
(2) Components having a same material serial number are grouped into a same group.
(3) Whether to reset to 0 (that is, whether to display the virtual assembly graph single box and PCBA physical image single box at 0°, and to rotate to 0 according to the angle of the CAD design file) is determined, and zero reset data is generated. For example, the angle of the component in the virtual assembly graph single box on the left side of FIG. 5 is 90°, the angle of the component in the virtual assembly graph single box on the right side of FIG. 5 is 0°.

Step 5: At a server, update the first CAD component list based on a number of times of check of components in multi-check settings, to obtain a second CAD component list, generate a task list based on the component list L4, and generate a check list based on the second CAD component list and the component list L4, to assign a current task number in the task list to at least n₁ users not having a current task (in actual application, preferably, the tasks are assigned to users in a manner that the number is relatively equal).

In a specific embodiment, the updating of the first CAD component list based on a number of times of check of components in multi-check settings to obtain the second CAD component list includes:
when the components have polarities, updating the number of times of check in the first CAD component list to be n according to the number of times of check n in the multi-check settings, and when the components have no polarities, maintaining the number of times of check in the first CAD component list as 1, to generate the second CAD component list according to the first CAD component list undergone setting of the number of times of check.

It is to be noted that the position numbers of the components may also be set separately.

In addition, the server generates a task list, the task list includes task numbers, status, and results, and the results are empty by default firstly. The status includes: complete, incomplete, voided, and closed, and an initial status is incomplete by default.

A task number is generated according to the component list L4 selected from the first CAD component list. The selection method may include: generating a task number according to a front and/or back side in the first CAD component list. For example, in one example, the front side is a task 1, and the back side is a task 2.In another example, the front side and the back side are a task 1. Alternatively, a corresponding task number may be generated by manually selecting a component. The selection method is not limited.

In a specific embodiment, the generating of the check list based on the second CAD component list and the component list L4 includes: generating a check list according to the number of times of check in the second CAD component list and the component list L4, where the total number of components to be checked in the check list is a sum of the number of times of check in the component list L4, the check list includes position numbers, check results, users, status, and task numbers, the status indicates whether occupied, for example, FALSE indicates non-occupied and TRUE indicates occupied.

In a specific embodiment, the assigning of the current task number in the task list to at least n₁ users not having a current task includes: generating a user task list; and assigning a current task number in the task list to the at least n₁ users not having a current task in the user task list.

Specifically, the user task list is generated according to a user to which a

task can be assigned; during assignment of the task, a number of users not less than n₁ are selected, and a task number is assigned to a user not having a current task, that is, a user terminal corresponding to the user, so that the user is a personnel performing the task.

Then, the server starts a timing instruction: starting timing T.

Step 6: At a user end, obtain the current task number based on the task list, and obtain status of the current task number, to obtain, when the status of the current task number is incomplete or complete, a check list updated according to the status in the check list and a check result.

Specifically, the current task number is obtained based on the task list. Upon there being no current task numbers, the process is ended. Upon the current task number existing, the status of the current task number is obtained. Upon the status of the current task number being invalid or closed, the user is prompted of the status and ending the process. Upon the status of the current task number being incomplete or complete, the check list updated according to the status in the check list and the check result is obtained.

In other words, the user logs into a request server, the user obtains a current task number in the user task list, and if not, the process is ended; if yes, status in the task list is further queried; if the status is invalid or closed, the user is directly prompted of the status, and the process is ended; if he status is incomplete or complete, a next step is turned to.

In a specific embodiment, the obtaining of the check list updated according to the status in the check list and the check result includes:

S1: Obtain a list L1, where the list L1 is a list of components whose status in the check list is non-occupied and whose check result in the check list is empty.

S2: When the list L1 is empty and the check result is empty, prompt a current user that another user is performing the task, and in this case, the user who is performing the task will continue to execute the task; when the list L1 is empty and the check result in the check list is non-empty, end the process and prompt the current user that the check is completed, and again display a component failing in passing the check, so that the user checks the correctness of the component check result, and end timing T1.

S3: When the list L1 is non-empty, exclude any multi-check component that is in the list L1 and has been checked by the current user to generate a list L2.

Specifically, if a multi-check component has been checked by the current user, the component checked by the current user will be removed from the list L1 to generate the list L2.

S4: When the list L2 is empty and the check result is empty, prompt the current user that another user is performing the task, and in this case, the user who is performing the task will continue to execute the task; when the list L2 is empty and the check result in the check list is non-empty, end the process and prompt the current user that the check is completed, and again display a component failing in passing the check, so that the user checks the correctness of the component check result, and end timing T1.

S5: When the list L2 is non-empty, update the list L2 based on a grouping situation of a same material serial number to generate a list L3.

Specifically, if there are components having a same material serial number and the components of the same material serial number are grouped into a same group, components of which the number of components in the same group is greater than or equal to the single group number g are priorly ranked to update the list L2, so as to generate the list L3 by using the updated list L2; or if there are no components having a same material serial number, a query order in the list L2 is used by default, to generate a list L3, that is, the list L2 is the list L3.

It is to be noted that with the execution of the tasks, the list L1, the list L2, and the list L3 are dynamic and are to be constantly updated.

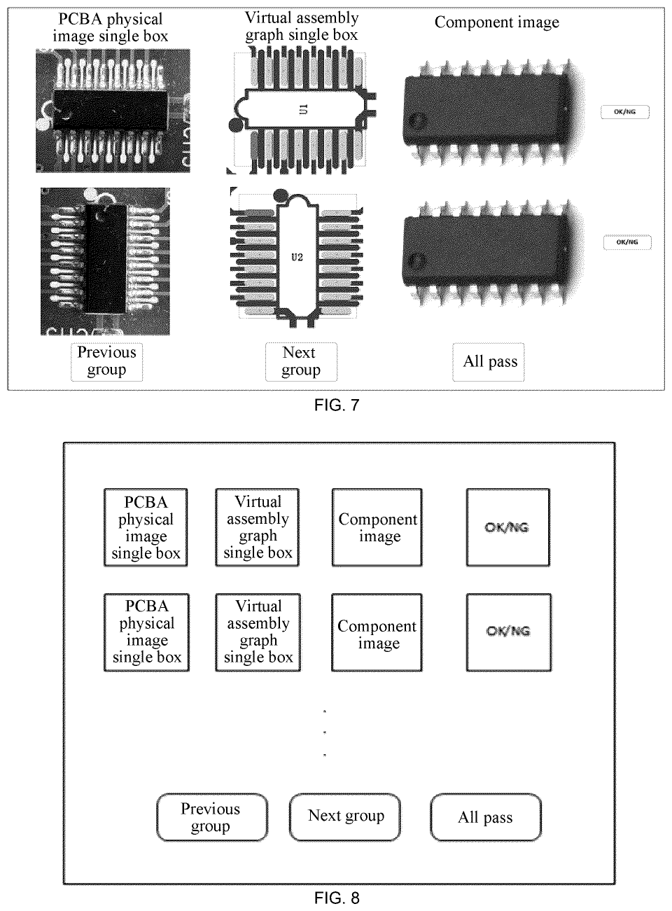

S6: determine whether to reset to zero according to settings of an assignment condition, if determining to reset to zero, perform displaying through a reset-to-zero interface, where the reset-to-zero interface is shown in FIG. 6; if determining not to reset to zero, perform displaying through a non-reset-to-zero interface, wherein the non-reset-to-zero interface is shown in FIG. 7. The assignment condition is set to whether to display the virtual assembly graph single box and PCBA physical image single box at 0°. When the display is at 0°, determine to reset to zero. When the display is not at 0°, determine not to reset to zero.

S7: Display component information corresponding to position numbers in the list L3 sequentially according to a single group number g, where the component information includes a virtual assembly diagram single box, a PCBA physical image single box, and a component image.

Specifically, according to the value g set according to the single group number, component information of the first g number in the list L3 is first pushed to a user-side interface, and then component information of g components is displayed in sequence at a time, and when the remaining quantity is less than g, the remaining components are all displayed.

The interface display content includes: a virtual assembly graph single box (displaying single box according to a size of a check box), a PCBA physical image single box, and a component image, whether the select box is OK/NG, a previous group or a next group of buttons, and all pass, for example, as shown in FIG. 8. In addition, in terms of a plug-in, the PCBA physical image single box and a welding surface also need to be displayed.

A check box on the interface shown in FIG. 8 shows: a virtual assembly graph single box (rotating the virtual assembly graph to zero according to the angle of the CAD design file, and displaying it at 0°), a PCBA physical image single box (rotating the PCBA physical image to zero according to the angle of the CAD design file, and displaying it at 0°), and a component image.

S8: Update status and a user name of a corresponding position number in the check list, and obtain a check result of the corresponding position number of the check list based on the component information, until all check results in the check list are non-empty.

Specifically, the status corresponding to the position number in the check list is changed to TRUE, indicating it is occupied, and the user is changed to a requested user name.

Subsequently, the user checks to determine that the check result corresponding to the position number is OK or NG, where OK represents that the result is normal, that is, passed, NG represents abnormal, that is, not passed. It is to be noted that OK and NG are not limited in this embodiment, and they may be opposite phrases such as pass and fail.

Therefore, after one group is completed, a cycle is performed according to step 6, until the task check assigned to the current user is completed.

Step 7: At the server, after all results in the check list are updated, obtain a task list whose status is closed and whose current task number is cleared, and generate and output a report of the current task number.

In a specific embodiment, step 7 may include step 7.1 to step 7.2.

Step 7.1: When all check results of the position numbers corresponding to the current task numbers in the check list are non-empty, obtain the task list of which the status is updated to be complete, and assign an overall inspection result to the results in the task list.

Specifically, a system administrator logs into the server and checks whether the current task number in the task list is completed. Whether one of the check results of the position number corresponding to the current task number in the check list is empty is checked. If one of the check results is empty, it is determined that the task is incomplete, that is, the task is to be continuously completed by the user at the user end. If all the check results are not empty, it is determined that the task is complete, the status in the task list is changed from incomplete to complete, and the timing T1 is ended; and the overall inspection result is assigned to results in the task list, where as long as one component appears as NG, the conclusion is overall NG.

Step 7.2: Obtain the task list whose status is closed and whose current task number is cleared, and generate and output the report of the current task number.

Specifically, the system administrator closes the task, searches for a task number in the task list, changes the status to be closed, and clears the task number in the user task list. A report of the task number is output.

Preferably, the report includes a final check result of the current task number, and/or a passing proportion, and/or an average check time per component, and/or a position number, and/or a position number overall result, and/or an inspector, and/or a single position number result, and/or a number of times.

Further, report content of the report is output (including at least the following four parts of content):
(1) The final check result of the task number is NG or OK (as long as one component appears as NG, the conclusion is overall NG, that is, the result is NG).
(2) A process for calculating the passing proportion is as follows:

A first type: calculating a passing proportion by components, where the passing proportion= (total number of component list L4-number of NG in component list L4)/total number of component list L4.

A second type: calculating a passing proportion according to the number of times of check, where the passing proportion = (total number of times of check of components-number of times of NG)/total number of times of check of components.
(3) A method for calculating an average time for single component inspection is as follows:

Average time for single component inspection=(T1−T)/total number of times of check of components, where T1−T is a total time, and the unit is seconds.
(4) A specific report is shown in Table 1 (NG is at the top). The report includes the signatures of relevant personnels such as inspectors, supervisors, and QA. Whether the overall check result of the position number is OK/NG: for example, if the position number is checked by two users and check results of the two users are OK, the overall check result of the position number is OK; if a check result of one of the two users is NG, the overall check result of the position number is NG.

TABLE 1

| | Whether the | | Whether a | | Whether a | |
|---|---|---|---|---|---|---|
| | overall check | | single check | | single check | |
| | result of the | | result of the | | result of the | |
| Position | position number | | position number | | position number | Number of |
| number | is OK or NG | Inspector | is OK or NG | Inspector | is OK or NG | times |
| xx | NG | User I | NG | User 2 | NG | 2 |
| xx-01 | NG | User I | OK | | | |
| . . . | . . . | . . . | . . . | . . . | . . . | |

In the present disclosure, the component list L4 including all of the components for the first article inspection is generated, and at the server, the task list and the check list are generated so that a task currently required to be performed can be assigned to the user end of a user who needs to perform the task. Then, at the user end, the user can perform the task whose status of the current task number is complete or incomplete, to obtain the check list having the check result, so as to finally output the corresponding report. Therefore, by the present disclosure, the inspection tasks can be dynamically assigned, the first article inspection can be performed by multiple people in parallel, multiple times of re-check or cross-check can be set, so that the time is shortened and the error rate of inspection is reduced.

### Embodiment 2

On the basis of the foregoing embodiments, this embodiment further provides a PCBA first article inspection method. The method includes:
1. After reading the BOM in combination with the CAD design file, form a whole-board virtual assembly graph.
2. Search for a corresponding material serial number, a component image, and a check box size in a component library according to the BOM.
3. Obtain a PCBA physical image through AOI scanning, and set the size of the image to obtain the PCBA physical image.
4. Overlap the whole-board virtual assembly graph and the PCBA physical image by 1:1, to obtain a virtual first article inspection graph; generate the first CAD component list, where the number of times of check in the first CAD component list is 1 by default. The first CAD component list is shown in Table 2.

TABLE 2
First CAD component list

| | | Whether it | Front and | Number of |
|---|---|---|---|---|
| Position | Material | has a | back | times |
| number | No. | polarity | surfaces | of check |
| R1 | PN10 | None | TOP | 1 |
| R2 | PN10 | None | TOP | 1 |
| R3 | PN10 | None | TOP | 1 |
| R4 | PN10 | None | TOP | 1 |
| R5 | PN2 | None | TOP | 1 |
| R6 | PN3 | None | TOP | 1 |
| R7 | PN3 | None | TOP | 1 |
| C1 | PN5 | None | TOP | 1 |
| C2 | PN6 | None | TOP | 1 |
| C3 | PN7 | Yes | TOP | 1 |
| C4 | PN7 | None | TOP | 1 |
| D1 | PN8 | Yes | TOP | 1 |
| D2 | PN9 | Yes | TOP | 1 |
| D3 | PN9 | Yes | TOP | 1 |
| D4 | PN9 | Yes | TOP | 1 |
| D5 | PN9 | Yes | TOP | 1 |
| U1 | PN13 | Yes | TOP | 1 |
| U2 | PN11 | Yes | TOP | 1 |
| U3 | PN12 | Yes | TOP | 1 |
| U4 | PN13 | Yes | TOP | 1 |
| Q1 | PN14 | Yes | TOP | 1 |
| Q2 | PN14 | Yes | TOP | 1 |
| Q9 | PN14 | Yes | BOTTOM | 1 |

5. Multi-check settings and check conditions:

Set double check when the components have polarities, and set single check when the components have no polarities; form a second CAD component list, as shown in Table 3.

TABLE 3
Second CAD component list

| | | Whether it | Front and | Number of |
|---|---|---|---|---|
| Position | Material | has a | back | times |
| number | No. | polarity | surfaces | of check |
| R1 | PN10 | None | TOP | 1 |
| R2 | PN10 | None | TOP | 1 |
| R3 | PN10 | None | TOP | 1 |
| R4 | PN10 | None | TOP | 1 |
| R5 | PN2 | None | TOP | 1 |
| R6 | PN3 | None | TOP | 1 |
| R7 | PN3 | None | TOP | 1 |
| C1 | PN5 | None | TOP | 1 |
| C2 | PN6 | None | TOP | 1 |
| C3 | PN7 | Yes | TOP | 2 |
| C4 | PN7 | None | TOP | 1 |
| D1 | PN8 | Yes | TOP | 2 |
| D2 | PN9 | Yes | TOP | 2 |
| D3 | PN9 | Yes | TOP | 2 |
| D4 | PN9 | Yes | TOP | 2 |
| D5 | PN9 | Yes | TOP | 2 |
| U1 | PN13 | Yes | TOP | 2 |
| U2 | PN11 | Yes | TOP | 2 |
| U3 | PN12 | Yes | TOP | 2 |
| U4 | PN13 | Yes | TOP | 2 |
| Q1 | PN14 | Yes | TOP | 2 |
| Q2 | PN14 | Yes | TOP | 2 |
| Q9 | PN14 | Yes | BOTTOM | 2 |

6. Select components on which first article inspection needs to be performed, and generate the component list L4, as shown in Table 4.

TABLE 4
Component list L4

| | | Whether it | Front and |
|---|---|---|---|
| Position | Material | has a | back |
| number | No. | polarity | surfaces |
| R1 | PN10 | None | TOP |
| R2 | PN10 | None | TOP |
| R3 | PN10 | None | TOP |
| R4 | PN10 | None | TOP |
| R5 | PN2 | None | TOP |
| R6 | PN3 | None | TOP |
| R7 | PN3 | None | TOP |
| C1 | PN5 | None | TOP |
| C2 | PN6 | None | TOP |
| C3 | PN7 | Yes | TOP |
| C4 | PN7 | None | TOP |
| D1 | PN8 | Yes | TOP |
| D2 | PN9 | Yes | TOP |
| D3 | PN9 | Yes | TOP |
| D4 | PN9 | Yes | TOP |
| D5 | PN9 | Yes | TOP |
| U1 | PN13 | Yes | TOP |
| U2 | PN11 | Yes | TOP |
| U3 | PN12 | Yes | TOP |
| U4 | PN13 | Yes | TOP |
| Q1 | PN14 | Yes | TOP |
| Q2 | PN14 | Yes | TOP |

7: Set a number of inspectors and set an assignment condition:
a. Setting the number of inspectors:

Set the PCBA first article check time t=180 s.

Obtain a total number of times of check of the components on the whole-board virtual assembly graph: Q=34.

An estimated time for one individual to process one component is t₁=6 s.

The number of people required for tasks: n₁=Q*t₁/t=34*6/180=1.13≈2.
b: Setting the assignment condition:

Recommend a single group number g=10.

Group components having a same material serial number into a same group, that is, [components having a same material serial number being grouped into a same group]=TRUE.

Rotate the virtual assembly graph single box and the PCBA physical image single box of the components to 0 according to the angle of the CAD design file, that is, [whether to reset to 0] =TRUE.
8. Dynamic assignment
1. Server
(1) The server generates a task list, status of which is incomplete by default, and a result of which is empty by default. A task 1 is generated according to the selected component list L4. The task list is shown in Table 5.

TABLE 5
Task list

| Task No. | Status | Result |
|---|---|---|
| Task 1 | Incomplete | |

(2) The server generates a check list according to the number of times of check in the second CAD component list and the component list L4 selected from the first CAD component list, and the total number is a sum of the number of times of check in the component list L4, as shown in Table 6.

TABLE 6
Check list

| | | | Status | |
|---|---|---|---|---|
| Position | Check | | (whether it is | |
| number | result | User | occupied) | Task No. |
| R1 | | | FALSE | Task 1 |
| R2 | | | FALSE | Task 1 |
| R3 | | | FALSE | Task 1 |
| R4 | | | FALSE | Task 1 |
| R5 | | | FALSE | Task 1 |
| R6 | | | FALSE | Task 1 |
| R7 | | | FALSE | Task 1 |
| C1 | | | FALSE | Task 1 |
| C2 | | | FALSE | Task 1 |
| C3 | | | FALSE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(3) The user task list is generated according to a user to which a task can be assigned, and during assignment of a task, a number of users not less than n₁=2 are selected, and the task number is assigned to users who do not have a current task. The user task list is shown in Table 7.

TABLE 7
User task list

| User | Current task |
|---|---|
| User I | Task 1 |
| User 2 | Task 1 |
| User 3 | |
| User 4 | |
| User 5 | |
| User 6 | |
| User 7 | |

2. User end:
(1) Start timing T =0.
(2) The User I logs into the request server, obtains from the user task list that a current task number=task 1, then checks whether status corresponding to the task 1 in the task list is incomplete, and turns to a next step.
(3) Query the check list for a component which is non-occupied and [a check result] is empty, to generate a list L1. The list L1 is shown in Table 8.

TABLE 8
List L1

| Position | Check | | Status (whether it is | |
|---|---|---|---|---|
| number | result | User | occupied) | Task No. |
| R1 | | | FALSE | Task 1 |
| R2 | | | FALSE | Task 1 |
| R3 | | | FALSE | Task 1 |
| R4 | | | FALSE | Task 1 |
| R5 | | | FALSE | Task 1 |
| R6 | | | FALSE | Task 1 |
| R7 | | | FALSE | Task 1 |
| C1 | | | FALSE | Task 1 |
| C2 | | | FALSE | Task 1 |
| C3 | | | FALSE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(4) Exclude double-checked components that have been checked by the User I, remove the components from the list L1, and generate a list L2. The list L2 is shown in Table 9.

TABLE 9
List L2

| Position | Check | | Status (whether it | Task |
|---|---|---|---|---|
| number | result | User | is occupied) | No. |
| R1 | | | FALSE | Task 1 |
| R2 | | | FALSE | Task 1 |
| R3 | | | FALSE | Task 1 |
| R4 | | | FALSE | Task 1 |
| R5 | | | FALSE | Task 1 |
| R6 | | | FALSE | Task 1 |
| R7 | | | FALSE | Task 1 |
| C1 | | | FALSE | Task 1 |
| C2 | | | FALSE | Task 1 |
| C3 | | | FALSE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(5) [Components having a same material serial number being grouped into a same group]=TRUE, components of a quantity greater than or equal to a single group number g=10 are priorly ranked, to generate a list L3. The list L3 is shown in Table 10.

TABLE 10
List L3

| Position | Check | | Status (whether it | |
|---|---|---|---|---|
| number | result | User | is occupied) | Task No. |
| R1 | | | FALSE | Task 1 |
| R2 | | | FALSE | Task 1 |
| R3 | | | FALSE | Task 1 |
| R4 | | | FALSE | Task 1 |
| R5 | | | FALSE | Task 1 |
| R6 | | | FALSE | Task 1 |
| R7 | | | FALSE | Task 1 |
| C1 | | | FALSE | Task 1 |
| C2 | | | FALSE | Task 1 |
| C3 | | | FALSE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(6) Whether to reset to 0 in the assignment condition=TRUE.

(7) According to the single group number g=10, information of first 10 components in the list L3 is pushed to a user-side interface; in addition, the status corresponding to the position numbers corresponding to the components in the check list is changed to TRUE, and the user in the check list is changed to the User 1. The check list is shown in Table 11.

TABLE 11
Check list

| Position | Check | | Status (whether it | |
|---|---|---|---|---|
| number | result | User | is occupied) | Task No. |
| R1 | | User I | TRUE | Task 1 |
| R2 | | User I | TRUE | Task 1 |
| R3 | | User I | TRUE | Task 1 |
| R4 | | User I | TRUE | Task 1 |
| R5 | | User I | TRUE | Task 1 |
| R6 | | User I | TRUE | Task 1 |
| R7 | | User I | TRUE | Task 1 |
| C1 | | User I | TRUE | Task 1 |
| C2 | | User I | TRUE | Task 1 |
| C3 | | User I | TRUE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(8) The user checks to determine that the check results corresponding to the position numbers are OK or NG. An updated check list is shown in Table 12.

TABLE 12
Check list

| Position | Check | | Status (whether it | |
|---|---|---|---|---|
| number | result | User | is occupied) | Task No. |
| R1 | OK | User I | TRUE | Task 1 |
| R2 | NG | User I | TRUE | Task 1 |
| R3 | OK | User I | TRUE | Task 1 |
| R4 | OK | User I | TRUE | Task 1 |
| R5 | OK | User I | TRUE | Task 1 |
| R6 | OK | User I | TRUE | Task 1 |
| R7 | NG | User I | TRUE | Task 1 |
| C1 | OK | User I | TRUE | Task 1 |
| C2 | OK | User I | TRUE | Task 1 |
| C3 | OK | User I | TRUE | Task 1 |
| C4 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |
| C3 | | | FALSE | Task 1 |
| D1 | | | FALSE | Task 1 |
| D2 | | | FALSE | Task 1 |
| D3 | | | FALSE | Task 1 |
| D4 | | | FALSE | Task 1 |
| D5 | | | FALSE | Task 1 |
| U1 | | | FALSE | Task 1 |
| U2 | | | FALSE | Task 1 |
| U3 | | | FALSE | Task 1 |
| U4 | | | FALSE | Task 1 |
| Q1 | | | FALSE | Task 1 |
| Q2 | | | FALSE | Task 1 |

(9) Complete one group, again circularly perform steps (2) to (8) in step 2, until task check assigned to the current user is completed. When all check tasks of User I and User 2 are completed, a final check list is shown in Table 13.

TABLE 13
Check list

| Position | Check | | Status (whether | |
|---|---|---|---|---|
| number | result | User | it is occupied) | Task No. |
| R1 | OK | User I | TRUE | Task 1 |
| R2 | NG | User I | TRUE | Task 1 |
| R3 | OK | User I | TRUE | Task 1 |
| R4 | OK | User I | TRUE | Task 1 |
| R5 | OK | User I | TRUE | Task 1 |
| R6 | OK | User I | TRUE | Task 1 |
| R7 | NG | User I | TRUE | Task 1 |
| C1 | OK | User I | TRUE | Task 1 |
| C2 | OK | User I | TRUE | Task 1 |
| C3 | OK | User I | TRUE | Task 1 |
| C4 | OK | User I | TRUE | Task 1 |
| D1 | OK | User I | TRUE | Task 1 |
| D2 | OK | User I | TRUE | Task 1 |
| D3 | OK | User I | TRUE | Task 1 |
| D4 | OK | User I | TRUE | Task 1 |
| D5 | OK | User I | TRUE | Task 1 |
| U1 | OK | User I | TRUE | Task 1 |
| U2 | OK | User I | TRUE | Task 1 |
| U3 | OK | User I | TRUE | Task 1 |
| U4 | OK | User I | TRUE | Task 1 |
| Q1 | OK | User I | TRUE | Task 1 |
| Q2 | OK | User I | TRUE | Task 1 |
| C3 | NG | User 2 | TRUE | Task 1 |
| D1 | OK | User 2 | TRUE | Task 1 |
| D2 | OK | User 2 | TRUE | Task 1 |
| D3 | OK | User 2 | TRUE | Task 1 |
| D4 | OK | User 2 | TRUE | Task 1 |
| D5 | OK | User 2 | TRUE | Task 1 |
| U1 | OK | User 2 | TRUE | Task 1 |
| U2 | OK | User 2 | TRUE | Task 1 |
| U3 | OK | User 2 | TRUE | Task 1 |
| U4 | OK | User 2 | TRUE | Task 1 |
| Q1 | OK | User 2 | TRUE | Task 1 |
| Q2 | OK | User 2 | TRUE | Task 1 |

(10) The system administrator logs into the server and checks whether a task 1 in the task list is completed. When it is checked that all the check results of the position numbers corresponding to the task 1 in the check list are non-empty, the first article inspection is completed, and the status in the task list is changed from incomplete to complete, and timing is ended, TI=180 s; an overall inspection result is assigned to the results in the task list, and an updated task list is shown in Table 14.

TABLE 14
Task list

| Task No. | Status | Result |
|---|---|---|
| Task 1 | Complete | NG |

(11) The system administrator closes the task, searches for a task 1 in the task list, changes the status to be closed, and clears the task 1 in the user task list. A report of the task 1 is output. An updated task list and user task list are shown in Table 15 and Table 16.

TABLE 15
Task list

| Task No. | Status | Result |
|---|---|---|
| Task 1 | Closed | NG |

TABLE 16
User task list

| User | Current task |
|---|---|
| User I | |
| User 2 | |
| User 3 | |
| User 4 | |
| User 5 | |
| User 6 | |
| User 7 | |

9. Output a report:
(1) A final check result of the task 1 is NG.
(2) A process for calculating the passing proportion is as follows:

A first method: calculating by components, where a passing proportion=(22×3)/22=86.36%;

A second method: calculating according to the number of times of check, where a passing proportion=(34-3)/34=91.17%.
(3) A process for calculating an average time for single component inspection is as follows:

Average time for single component inspection=(180-0)/34=5.29.
(4) A specific report is shown in the following table (NG is at the top). The report includes the signatures of relevant personnels such as inspectors, supervisors, and QA. The report is shown in Table 17.

TABLE 17
Report

| | Whether the | | Whether a | | Whether a | |
|---|---|---|---|---|---|---|
| | overall check | | single check | | single check | |
| | result of the | | result of the | | result of the | Number of |
| Position | position number | | position number | | position number | times of |
| number | is OK or NG | Inspector | is OK or NG | Inspector | is OK or NG | check |
| R2 | NG | User I | NG | / | / | 1 |
| R7 | NG | User 1 | NG | / | / | 1 |
| C3 | NG | User 1 | OK | User 2 | NG | 2 |
| R1 | OK | User 1 | OK | / | / | 1 |
| R3 | OK | User 1 | OK | / | / | 1 |
| R4 | OK | User 1 | OK | / | / | 1 |
| R5 | OK | User 1 | OK | / | / | 1 |
| R6 | OK | User 1 | OK | / | / | 1 |
| C1 | OK | User 1 | OK | / | / | 1 |
| C2 | OK | User 1 | OK | / | / | 1 |
| C4 | OK | User 1 | OK | / | / | 1 |
| D1 | OK | User 1 | OK | User 2 | OK | 2 |
| D2 | OK | User 1 | OK | User 2 | OK | 2 |
| D3 | OK | User 1 | OK | User 2 | OK | 2 |
| D4 | OK | User 1 | OK | User 2 | OK | 2 |
| D5 | OK | User 1 | OK | User 2 | OK | 2 |
| U1 | OK | User 1 | OK | User 2 | OK | 2 |
| U2 | OK | User 1 | OK | User 2 | OK | 2 |
| U3 | OK | User 1 | OK | User 2 | OK | 2 |
| U4 | OK | User 1 | OK | User 2 | OK | 2 |
| Q1 | OK | User 1 | OK | User 2 | OK | 2 |
| Q2 | OK | User 1 | OK | User 2 | OK | 2 |

### Embodiment 3

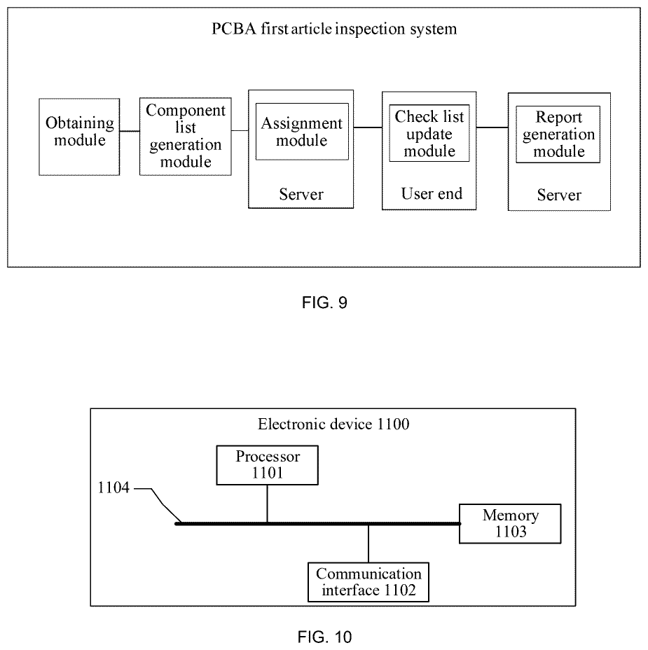

Referring to FIG. 9, FIG. 9 is a schematic diagram of a PCBA first article inspection system according to an embodiment of the present disclosure. The PCBA first article inspection system includes an obtaining module, a component list generation module, an assignment module, a check list update module, and a report generation module.

Then obtaining module can obtain a whole-board virtual assembly graph, a PCBA physical image, and a first CAD component list.

The component list generation module can extract a component list L4 from the first CAD component list, where the component list L4 includes all components for first article inspection.

The assignment module is disposed at a server, and can update the first CAD component list based on a number of times of check of components in multi-check settings to obtain a second CAD component list, generate a task list based on the component list L4, and generate a check list based on the second CAD component list and the component list L4, to assign a current task number in the task list to at least n₁ users not having a current task.

The check list update module is disposed at a user end. It can obtain the current task number based on the task list, and obtain status of the current task number, to obtain, when the status of the current task number is incomplete or complete, a check list updated according to the status in the check list and a check result.

The report generation module is disposed at the server. After all results in the check list are updated, the report generation module can obtain a task list whose status is closed and whose current task number is cleared, and generate and output a report of the current task number.

The PCBA first article inspection system provided in this embodiment may execute the foregoing method embodiments. Implementation principles and technical effects thereof are similar, and details are not described herein again.

### Embodiment 4

Referring to FIG. 10, FIG. 10 is a schematic structural diagram of an electronic device according to this embodiment. The electronic device 1100 includes a processor 1101, a communication interface 1102, a memory 1103, and a communication bus 1104. The processor 1101, the communication interface 1102, and the memory 1103 complete communication with each other through the communication bus 1104.

The memory 1103 can store a computer program.

The processor 1101, when executing a computer program, can implement all or part of the steps in the foregoing embodiments of the PCBA first article inspection method. Specific implementation principles and technical effects thereof are similar, and details are not described herein again.

### Embodiment 5

This embodiment provides a computer-readable storage medium, having a computer program stored thereon, where the computer program, when executed by a processor, implements all or part of the steps in the foregoing embodiments of the PCBA first article inspection method. Specific implementation principles and technical effects thereof are similar, and details are not described herein again.

A person skilled in the art may understand that the embodiments of this application may be provided as a method, an apparatus (device), or a computer program product. Accordingly, this application may adopt a form of an entirely hardware embodiment, an entirely software embodiment, or an embodiment combining software and hardware aspects, all of which are collectively referred to herein as a “module” or a “system”. Moreover, this application may use a form of a computer program product implemented on one or more computer-readable storage media (including, but not limited to, a disk storage device, a CD-ROM, an optical memory, or the like) including computer-usable program code. The computer program is stored/distributed in a suitable medium, supplied together with or as part of other hardware, and may also take other forms of distribution, such as via Internet or other wired or wireless telecommunications systems.

In the description of the present disclosure, it is to be understood that the terms “first” and “second” are used merely for the purpose of description, and cannot be understood as indicating or implying relative importance or implicitly indicating a quantity of indicated technical features. In the description of the present disclosure, the meaning of “a plurality of” means two or more unless otherwise specified.

In the description of this specification, the description of the reference terms such as “an embodiment”, “some embodiments”, “example”, “specific example”, or “some examples” means that the specific features, structures, or characteristics described with reference to the embodiment or example are included in at least an embodiment or example of the present disclosure. In this specification, exemplary descriptions of the foregoing terms are not necessarily directed to the same embodiment or example. Moreover, the specific features, structures, or characteristics described may be combined in a suitable manner in any one or more embodiments or examples.

The foregoing content is a further detailed description of the present disclosure in combination with specific preferred embodiments, and it cannot be considered that the specific implementation of the present disclosure is only limited to these descriptions. For those of ordinary skill in the art to which the present disclosure pertains, several simple deductions or substitutions can be made without departing from the concept of the present disclosure, which should be regarded as relating to the scope of protection of the present disclosure.

1. A PCBA first article inspection method, comprising:
obtaining a whole-board virtual assembly graph, a PCBA physical image, and a first CAD component list;
extracting a component list L4 from the first CAD component list, wherein the component list L4 comprises all components for first article inspection;
at a server, updating the first CAD component list based on a number of times of check of components in multi-check settings to obtain a second CAD component list, generating a task list based on the component list L4, and generating a check list based on the second CAD component list and the component list L4, to assign a current task number in the task list to at least n₁ users not having a current task;
at a user end, obtaining the current task number based on the task list, and obtaining status of the current task number, to obtain, when the status of the current task number is incomplete or complete, a check list updated according to the status in the check list and a check result; and
at the server, after all results in the check list are updated, obtaining a task list whose status is closed and whose current task number is cleared, and generating and outputting a report of the current task number.

2. The PCBA first article inspection method as in claim 1, wherein the obtaining of the whole-board virtual assembly graph, the PCBA physical image, and the first CAD component list comprises:
forming the whole-board virtual assembly graph by combining a BOM and a CAD design file;
obtaining a PCBA physical image corresponding to a PCBA board; and
forming the first CAD component list comprising all of the components based on the CAD design file.

3. The PCBA first article inspection method as in claim 1, wherein the updating of the first CAD component list based on the number of times of check of components in multi-check settings to obtain the second CAD component list comprises:
when the components have polarities, updating the number of times of check in the first CAD component list to be n according to the number of times of check n in the multi-check settings, and when the components have no polarities, maintaining the number of times of check in the first CAD component list as 1, to generate the second CAD component list according to the first CAD component list undergone setting of the number of times of check, wherein n≥2.

4. The PCBA first article inspection method as in claim 1, wherein the generating of the check list based on the second CAD component list and the component list L4 comprises:
generating the check list based on the number of times of check in the second CAD component list and the component list L4.

5. The PCBA first article inspection method as in claim 1, wherein a number of people for tasks n₁ is:
n₁=Q*t₁/t
wherein tis a first article check time, t₁ is a processing time of each component, and Q is a total number of times of check of components on the component list L4.

6. The PCBA first article inspection method as in claim 1, wherein the assigning of the current task number in the task list to at least n₁ users not having a current task comprises:
generating a user task list; and
assigning the current task number in the task list to the at least n₁ users not having a current task in the user task list.

7. The PCBA first article inspection method as in claim 1, wherein the obtaining of the current task number based on the task list, and obtaining the status of the current task number, to obtain, when the status of the current task number is incomplete or complete, the check list updated according to the status in the check list and the check result comprises:
obtaining the current task number based on the task list, upon there being no current task numbers, ending the process; upon the current task number existing, obtaining the status of the current task number; upon the status of the current task number being invalid or closed, prompting the user of the status and ending the process; upon the status of the current task number being incomplete or complete, obtaining the check list updated according to the status in the check list and the check result.

8. The PCBA first article inspection method as in claim 7, wherein the obtaining of the check list updated according to the status in the check list and the check result comprises:
obtaining a list L1, wherein the list L1 is a list of components whose status in the check list is non-occupied and whose check result in the check list is empty;
when the list L1 is empty and the check result in the check list is empty, prompting the current user that there is another user performing the task; when the list L1 is empty and the check result in the check list is non-empty, ending the process and prompting the current user that the check is completed, and again displaying a component failing in passing the check;
when the list L1 is non-empty, excluding any multi-check component that is in the list L1 and has been checked by the current user to generate a list L2;
when the list L2 is non-empty, updating the list L2 based on a grouping situation of a same material serial number to generate a list L3;
displaying component information corresponding to position numbers in the list L3 sequentially according to a single group number g, wherein the component information comprises a virtual assembly diagram single box, a PCBA physical image single box, and a component image; and
updating status and a user name of a corresponding position number in the check list, and obtaining a check result of the corresponding position number of the check list based on the component information, until all check results in the check list is non-empty.

9. The PCBA first article inspection method as in claim 8, wherein after generating the list L2, the method further comprises:
when the list L2 is empty and the check result in the check list is empty, prompting the current user that there is another user performing the task; when the list L2 is empty and the check result in the check list is non-empty, ending the process and prompting the current user that the check is completed, and again displaying a component failing in passing the check.

10. The PCBA first article inspection method as in claim 8, wherein the updating of the list L2 based on a grouping situation of a same material serial number to generate a list L3 comprises:
upon there being components having a same material serial number and the components of the same material serial number having been grouped into a same group, priorly ranking components of which the number of components in the same group is greater than or equal to the single group number g to update the list L2, so as to generate the list L3 by using the updated list L2; upon there being no components having a same material serial number, using a query order in the list L2 by default to generate the list L3.

11. The PCBA first article inspection method as in claim 8, wherein before the displaying of the component information corresponding to the position numbers in the list L3 sequentially according to the single group number g, the method further comprises:
determining whether to reset to zero according to settings of an assignment condition; upon determining to reset to zero, performing displaying through a reset-to-zero interface; upon determining not to reset to zero, performing displaying through a non-reset-to-zero interface;
wherein the assignment condition is set to whether to display the virtual assembly graph single box and PCBA physical image single box at 0°; when the display is at 0°, determining to reset to zero; when the display is not at 0°, determining not to reset to zero.

12. The PCBA first article inspection method as in claim 8, wherein the obtaining the task list whose status is closed and whose current task number is cleared, and generating and outputting the report of the current task number comprises:
when all check results of the position numbers corresponding to the current task numbers in the check list are non-empty, obtaining the task list of which the status is updated to be complete, and assigning an overall inspection result to the results in the task list; and
obtaining the task list whose status is closed and whose current task number is cleared, and generating and outputting the report of the current task number.

13. The PCBA first article inspection method as in claim 1, wherein the report comprises a final check result of the current task number, and/or a passing proportion, and/or an average check time per component, and/or a position number, and/or an overall check result of the position number, and/or an inspector, and/or a single check result of the position number, and/or a number of times.

14. A PCBA first article inspection system, comprising:
an obtaining module, configured to obtain a whole-board virtual assembly graph, a PCBA physical image, and a first CAD component list;
a component list generation module, configured to extract a component list L4 from the first CAD component list, wherein the component list L4 comprises all components for first article inspection;
an assignment module, disposed at a server, and configured to update the first CAD component list based on a number of times of check of components in multi-check settings, to obtain a second CAD component list, generate a task list based on the component list L4, and generate a check list based on the second CAD component list and the component list L4, to assign a current task number in the task list to at least n₁ users not having a current task;
a check list update module, disposed at a user end, and configured to obtain the current task number based on the task list, and obtain status of the current task number, to obtain, when the status of the current task number is incomplete or complete, a check list updated according to the status in the check list and a check result; and
a report generation module, disposed at the server, and configured to: after all results in the check list are updated, obtain a task list whose status is closed and whose current task number is cleared, and generate and output a report of the current task number.

15. An electronic device, comprising a processor, a communication interface, a memory, and a communication bus, wherein the processor, the communication interface, and the memory complete communication with each other through the communication bus;
the memory is configured to store a computer program; and
the processor is configured to implement, when executing the computer program, the steps of the method as in claim 1.

16. A storage medium, wherein the storage medium has a computer program stored thereon, and the computer program, when executed by a processor, implements the steps of the method as in claim 1.
